(19) United States
(12) Patent Application Publication
(10) Pub. No.: US 2006/0018480 A1
(43) Pub. Date: Jan. 26, 2006

(54) Method for preventing eavesdropping in wireless communication system

(75) Inventor: Seiji Kachi, Tokyo (JP)

Correspondence Address: DICKSTEIN SHAPIRO MORIN & OSHINSKY LLP, 1177 AVENUE OF THE AMERICAS (6TH AVENUE), 41 ST FL., NEW YORK, NY, 10036-2714, US

(73) Assignee: NEC Corporation

(21) Appl. No.: 11/157,787

(22) Filed: Jun. 22, 2005

(30) Foreign Application Priority Data
Jun. 24, 2004 (JP) 2004-186507

(51) Int. Cl. H04K 1/00

(52) U.S. Cl. 380/270

(57) ABSTRACT

A wireless communication system includes an access point and a terminal exchanging a packet with the access point. When receiving the packet, the access point determines whether the received packet includes a Weak Initial Vector (Weak IV). When the packet includes the Weak IV, the access point transmits a disturbance packet that has been encrypted with an encryption key different from a predetermined encryption key.

### BACKGROUND OF THE INVENTION

1. Field of the Invention

The present invention relates to a wireless communication system and a method for preventing eavesdropping (tapping) in a wireless communication system and particularly, to a wireless communication system and a method for preventing eavesdropping in a wireless communication system capable of transmitting a packet that disrupts an analysis process in an eavesdropping terminal.

2. Description of the Related Art

Wireless LAN systems are now widely used and make communication environment more convenient than the use of wired LAN systems.

In the wired LAN, a diffusion of a switching HUB makes it difficult to receive other people's data in itself, so that it has not been necessary for users to care for security.

In the wireless LAN, however, it is possible to receive other people's data, and the wireless LAN systems are dependent on a WEP code with regards to security for preventing the content from being read.

The vulnerability of a WEP system has been pointed out for several years and, nowadays, it is possible for anyone to obtain free software for cracking the WEP key.

The following three systems are mainly available as encryption systems used in the wireless LAN:

Wired Equivalent Privacy (WEP)64/128

Temporal Key Integrity Protocol (TKIP)

Advanced Encryption Standard (AES)

Among the above encryption systems, the WEP system is the oldest and is implemented in approximately all wireless LAN equipment.

The WEP system is more advantageous than other two systems in terms of interoperability. However, an encryption protection becomes weaker when an Initialization Vector (IV) having a specified pattern is used, and the vulnerability thereof has been pointed out.

The IV having a specified pattern is called “Weak IV”. The document that points out the vulnerability in the Weak IV is disclosed and analysis tool for the Weak IV is disclosed as open source. As the document, the following non-patent document is adduced:
“Scott Fluhurer, Itsik Mantin, Adi shamir Weakness in the Key Scheduling Algorithm of RC4 (searched on Jun. 17, 2004)”<URL; http://www.drizzle.com/^{—}aboba/IEEE/rc4_ksaproc.pdf> As the analysis tool, Airsnort is adduced.

JPA 2004-015725 and JPA 2004-064531 can be taken as documents related to the present invention.

However, it is possible for an ordinary engineer having knowledge of Linux to crack the WEP by intercepting packets for several hours.

The TKIP and AES are new systems, so that there is little possibility that an encryption key is cracked when they are used. However, user's wireless LAN equipment may fail to conform to the new systems.

Although it may be unavoidable to utilize a more advanced technique such as the TKIP or AES in a public service such as a hot spot, the TKIP or AES is over-spec for the usage of only enjoying Web access in home. It is desirable to utilize WEP in terms of increase in the price of equipment and interoperability to existing equipment.

Further, more complicated processing is required and thereby more CPU power and memory space are required in the TKIP and AES than in the WEP. As above, the TKIP and AES are disadvantage in terms of cost.

Further, a protocol becomes more complicated in the TKIP and AES than in the case where the WEP is used, so that the slight setting miss will result in communication breakdown. In this regard, it is not easy for general users to handle the TKIP and AES. Special knowledge for trouble analysis is required in the TKIP and AES.

If it is possible to reconfigure all WLAN equipment, program installed in the equipment can be modified so as not to utilize the Weak IV. However, it is difficult to perform the above modification in embedded device or old equipment.

Although the disadvantage of the vulnerability can be avoided unless wireless LAN equipment uses the Weak IV in the first place, it is difficult to apply a modification for not using Weak IV to all the considerable number of equipment that have been shipped and it may be impossible to apply that to embedded equipment.

In the conventional eavesdropping system, an eavesdropping terminal tries to guess an encryption key on the basis that one encryption key is used.

Assuming that a password is “ABCDE”, if only this “ABCDE” is used as the password, the eavesdropping terminal guesses the password by the order like “..C..”→“.BC..”→“.BC.E.” when it receives packets having Weak IV and finally determines that the password is “ABCDE”. As a reconfirmation, the eavesdropping terminal decrypts a plurality of intercepted packets by the encryption key “ABCDE”, checks whether the original IP packets can be obtained or not, and finally determines that “ABCDE” is the password if the original IP packets can be obtained.

### SUMMARY OF THE INVENTION

An object of the present invention is to prevent decryption based on the Weak IV collection without reconfiguration of terminal equipment currently used.

According to a first aspect of the present invention, there is provided a method for preventing eavesdropping in a wireless communication system that includes an access point and a terminal exchanging, with the access point, a packet that has been encrypted with a first encryption key that has been previously set on the basis of a Wired Equivalent Privacy (WEP), the method comprising the steps of determining at the access point whether the packet includes a Weak Initial Vector (Weak IV) having a specified bit pattern, when the access point receives the packet, and

transmitting from the access point a disturbance packet that has been encrypted with a second encryption key different from the first encryption key, when the packet includes the Weak IV.

According to a second aspect of the present invention, there is provided a wireless communication system comprising an access point; and a terminal exchanging, with the access point, a packet that has been encrypted with a predetermined encryption key that has been previously set on the basis of a Wired Equivalent Privacy (WEP), the access point comprising determination unit for determining whether the received packet includes a Weak Initial Vector (Weak IV) having a specified bit pattern; and transmitter for transmitting a disturbance packet that has been encrypted with an encryption key different from the predetermined encryption key,

wherein the transmitter transmits the disturbance packet when the determination unit determines that the received packet includes the Weak IV.

According to a third aspect of the present invention, there is provided an access point of a wireless communication system including the access point and a terminal exchanging, with the access point, a packet that has been encrypted with a predetermined encryption key that has been previously set on the basis of a Wired Equivalent Privacy (WEP), the access point comprising determination unit for determining whether the received packet includes a Weak Initial Vector (Weak IV) having a specified bit pattern; and

transmitter for transmitting a disturbance packet that has been encrypted with an encryption key different from the predetermined encryption key,

wherein the transmitter transmits the disturbance packet when the determination unit determines that the received packet includes the Weak IV.

According to a fourth aspect of the present invention, there is provided a program product embodied on a storage unit of a computer and comprising code that, when the program product is executed, cause the computer to perform a method comprising the steps of determining at the access point whether the packet includes a Weak Initial Vector (Weak IV) having a specified bit pattern, when the access point receives the packet, and

transmitting from the access point a disturbance packet that has been encrypted with a second encryption key different from the first encryption key, when the packet includes the Weak IV.

### BRIEF DESCRIPTION OF THE DRAWINGS

FIG. 1 is a block diagram showing a configuration of a wireless communication system according to a first embodiment of the present invention;

FIG. 2 is a block diagram showing a configuration of an access point 101 according to the first embodiment of the present invention;

FIGS. 3A and 3B are views each showing a packet exchanged in the first embodiment of the present invention;

FIG. 4 is a flowchart showing an operation of the access point 101 of the wireless LAN system according to the first embodiment of the present invention;

FIG. 5 is a sequence diagram showing a packet communication between terminals according to the first embodiment of the present invention;

FIG. 6 is a flowchart showing another example of the operation of the access point 101 of the wireless LAN system according to the first embodiment of the present invention;

FIG. 7 is a flowchart showing an example of the operation of the wireless LAN system according to a second embodiment of the present invention in the access point 101; and

FIG. 8 is a sequence diagram showing a packet communication between terminals according to the second embodiment of the present invention.

### DETAILED DESCRIPTION OF THE PREFERRED EMBODIMENTS

Preferred embodiments of the present invention will be described below with reference to the accompanying drawings.

### First Embodiment

[Configuration]

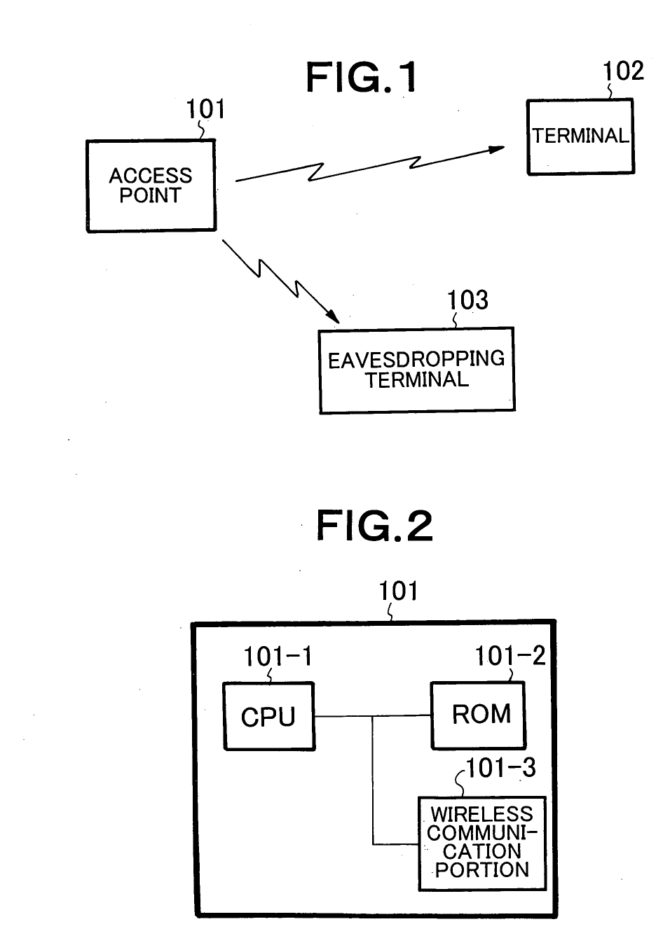

FIG. 1 is a block diagram showing a configuration of a wireless communication system according to a first embodiment of the present invention.

As shown in FIG. 1, the wireless communication system according to the present embodiment includes access point 101 and terminal 102. The terminal 102 exchanges, with the access point 101, packets encrypted with a first encryption key (key 1) that has previously been set based on Wired Equivalent Privacy (WEP). Here, the packets exchanged between the access point 101 and terminal 102 are eavesdropped by eavesdropping terminal 103.

The eavesdropping terminal 103 only receives the packets exchanged between the access point 101 and terminal 102 and does not perform any data transmission operation for the access point 101 and terminal 102.

FIG. 2 is a block diagram showing a configuration of the access point 101 according to the present embodiment.

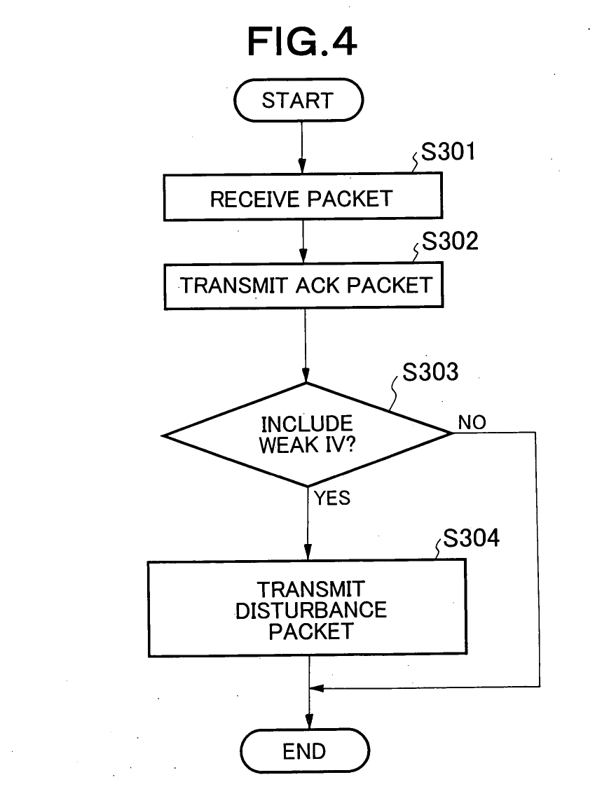

As shown in FIG. 2, the access point 101 includes CPU 101-1 that controls the entire system of the access point 101, ROM 101-2 that stores a control program of the CPU 101-1, and wireless communication portion 101-3 that performs a wireless communication. The access point 101 operates under the control of the CPU 101-1. The CPU 101-1 carries out information processings based on the program for performing the respective processings as described later by using FIGS. 4 and 5, 6, or 7 and 8. The wireless communication portion 101-3 comprises a transmitter and a receiver. The CPU 101-1 functions as a determination unit for determining whether the received packet includes Weak IV having a specified bit pattern, and as a timer for measuring a predetermined time. The access point 101 can be constructed as a computer. However, the access point 101 may be constructed by dedicated (exclusive use) ICs.

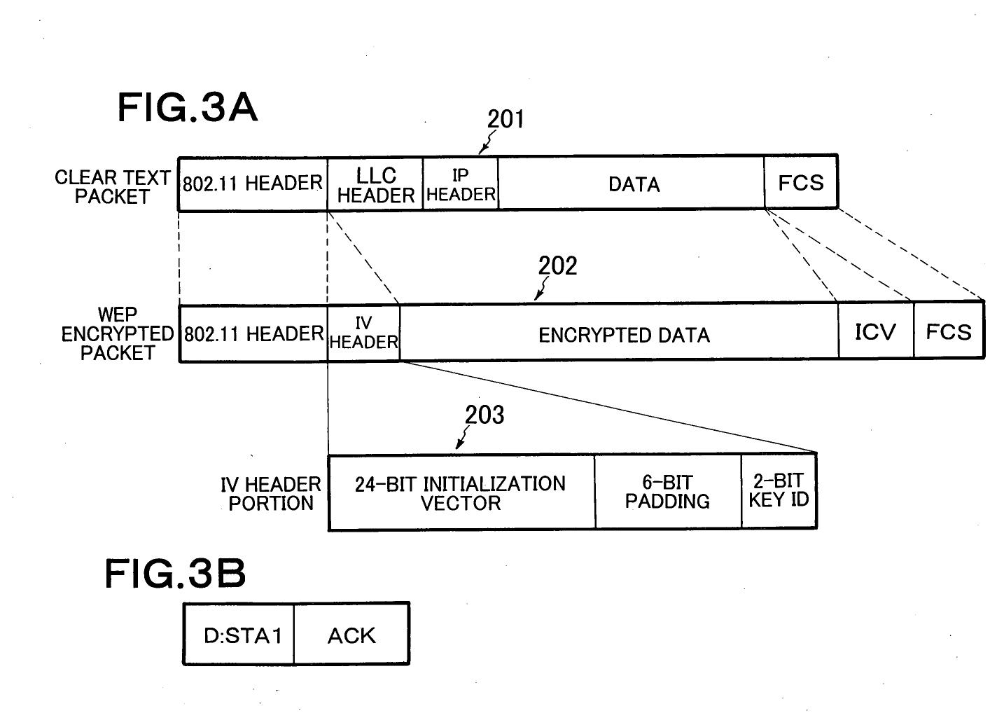

FIGS. 3A and 3B are views each showing a packet exchanged in the wireless system of the present embodiment.

FIG. 3A shows a packet exchanged between the access point 101 and terminal 102. FIG. 3B shows an acknowledgement (ACK) packet that the access point 101 sends for reception confirmation if it receives a packet.

In FIG. 3A, clear text packet 201 is a packet that is not encrypted, and a WEP encrypted packet 202 is a packet that has been encrypted with a WEP encryption method.

Initial vector (IV) header portion 203 denotes the details of the IV header portion in the WEP encrypted packet 202.

The clear text packet 201 is constituted by a 802.11 header, a Logical Link Control (LLC) header, an IP header, a data portion, and a Frame Check Sequence (FCS). A CRC-32 is generally used as the FCS in the wireless LAN system.

The WEP encrypted packet 202 is a packet obtained by encrypting the clear text packet 201 with the WEP encryption method. In this encryption, the IV header 203 and Integrity Check Value (ICV) are added to the clear text packet 201. In the present embodiment, each of the IV header 203 and ICV is 4 bytes.

In the present embodiment, packets that have been encrypted with the first encryption key, which is an ordinary encryption key, and packets that have been encrypted with a second encryption key (key 2) different from the common encryption key are exchanged in the system.

The 802.11 header includes information indicating a destination and information indicating a source.

The IV is an initial value used at the time of packet encryption and is different from the encryption key. In general, the IV differs for each packet. When the same IV is used among packets, the intercepted packets exhibit regularity, so that the encryption key becomes easy to be guessed.

The IV header 203 is constituted by an Initialization Vector (IV), a padding, and a key ID. In the present embodiment, the IV (Initialization Vector) is 24 bits, the padding is 6 bits, and the key ID is 2 bits.

The padding is data which compensate the shortage of data volume when data having the data volume are constructed as a certain size of format.

Among the 24 bit-IV, a value corresponding to the following bit patterns is Weak IV.

BBBBBB11, 11111111, XXXXXXXX

BBBBBB: key position exhibiting vulnerability

XXXXXXXX: optional (arbitrary) characters

For example, in the case where “BBBBBB”=“000000”, cracking on 0-th byte of the WEP key can be performed. In the case where “BBBBBB”=“000001”, cracking on 1-th byte of the WEP key can be performed.

Further, as shown in FIG. 3B, the ACK packet is constituted by a component denoting the destination and an ACK component. The destination component “D:STA1” denotes that the destination is the terminal 102.

In the present embodiment, the eavesdropping terminal 103 performs cracking on the basis that all of the collected packets have been encrypted with the same key, so that it is impossible to perform the key cracking if the eavesdropping terminal 103 collects the packet including a different key.

[Operation]

FIG. 4 is a flowchart showing an operation of the access point 101 of the wireless LAN system according to the present embodiment.

As shown in FIG. 4, the access point 101 receives a packet that has been encrypted with the WEP encryption method from the terminal 102 (step S301). The access point 101 transmits an ACK packet (step S302).

The access point 101 then determines whether the IV of the received packet is Weak IV or not (step S303). When the IV of the received packet is Weak IV (Yes in step S303), the access point 101 transmits a disturbance packet that has been encrypted using the Weak IV and an encryption key different from the ordinarily used encryption key (step S304).

The eavesdropping terminal 103 then uses the encryption key used in all the packets including the Weak IV to try to crack the encryption key of the received packet.

When receiving the disturbance packet that has been encrypted with an encryption key different from the commonly used encryption key, the eavesdropping terminal 103 cannot determine whether the received packet is encrypted with an ordinarily used encryption key or an encryption key different from the ordinarily used encryption key. Consequently, the eavesdropping terminal 103 fails to crack the encryption key.

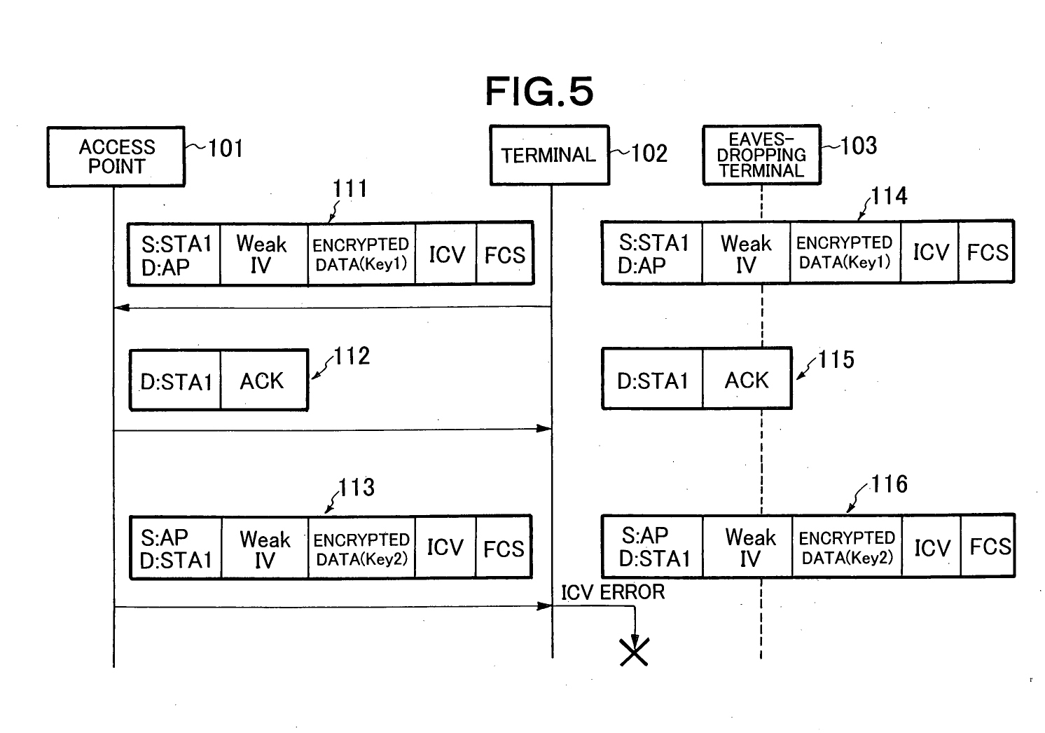

FIG. 5 is a sequence diagram showing a packet communication between terminals.

As shown in FIG. 5, the packets exchanged between the access point 101 and terminal 102 are monitored by the eavesdropping terminal 103. Here, packets encrypted with the first encryption key and those encrypted with the second encryption key are exchanged between them.

The terminal 102 transmits WEP encrypted packet 111 to the access point 101 and the eavesdropping terminal 103 eavesdrops on WEP encrypted packet 114 from the terminal 102. The access point 101 transmits ACK packet 112 to the terminal 102 and the eavesdropping terminal 103 eavesdrops on ACK packet 115 from the access point 101. Subsequently, The access point 101 transmits WEP encrypted packet 113 to the terminal 102 and the eavesdropping terminal 103 eavesdrops on WEP encrypted packet 116 from the access point 101. In each of the packets 111, 113, 114 and 116, 802.11 header includes information indicating a destination and information indicating a source. For example, the source component “S:STA1” denotes that the source is the terminal 102 and the destination component “D:AP” denotes that the destination is the access point 101.

[Another Operation Example]

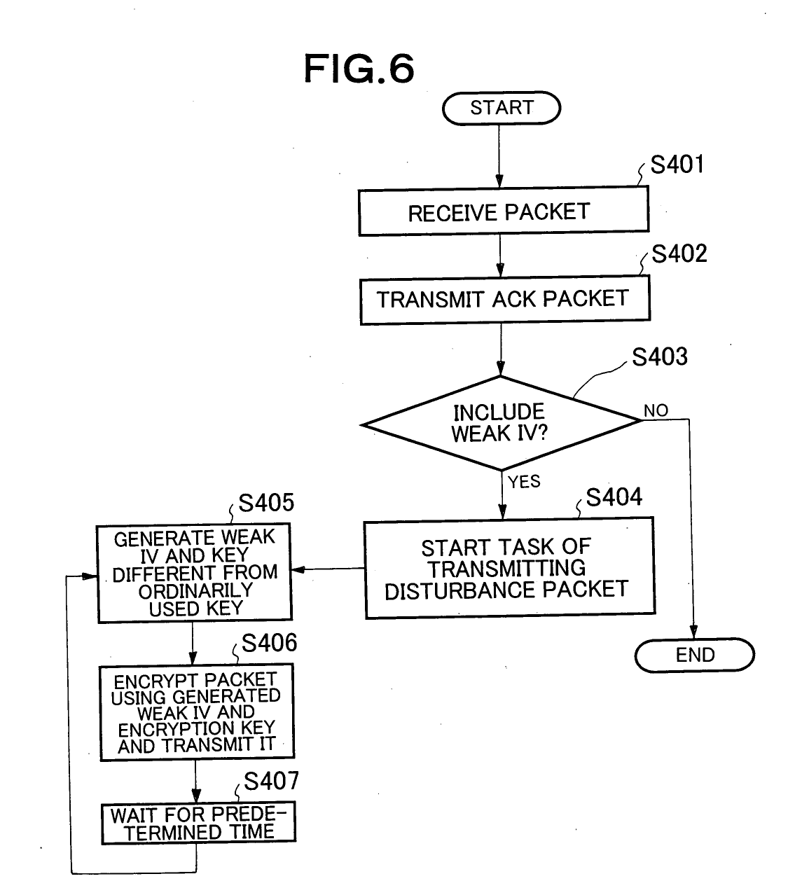

FIG. 6 is a flowchart showing another example of the operation of the access point 101 of the wireless LAN system according to the present embodiment.

As shown in FIG. 6, when the access point 101 receives a packet that has been encrypted with the WEP encryption method from the terminal 102 (step S401), the access point 101 transmits an ACK packet (step S402).

The access point 101 then determines whether the IV of the received packet is Weak IV or not (step S403). If the IV of the received packet is Weak IV (Yes in step S403), the access point 101 starts a task of transmitting a disturbance packet that has been encrypted with the Weak IV and an encryption key different from the ordinarily used encryption key (step S404)

In the task, the access point 101 firstly generates Weak IV and an encryption key different from the ordinarily used encryption key (step S405).

The access point 101 then uses the generated Weak IV and encryption key to encrypt the packet and transmits the encrypted packet (step S406).

The access point 101 then waits for a predetermined time period (step S407) and generates again Weak IV and an encryption key different from the commonly used one (step S405).

By repeating the above processes from step S405 to step S407, the access point 101 continues to transmit the disturbance packet at a predetermined interval.

There is no trigger to end the task of transmitting the disturbance packet in the present operation example. However, the wireless LAN system includes a mechanism of association, and the task can be ended on the basis of the association information.

Further, it is possible to increase the ratio of the disturbance packet by reducing the value of the predetermined time period in step S407.

### Second Embodiment

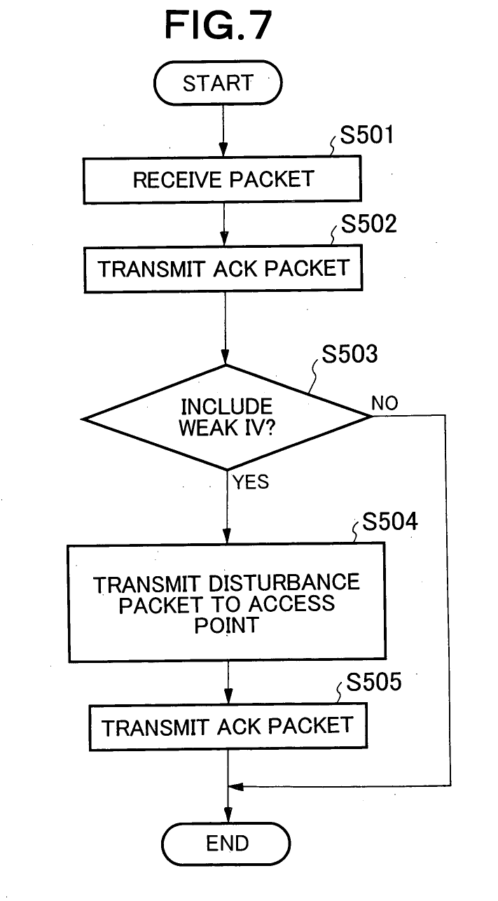

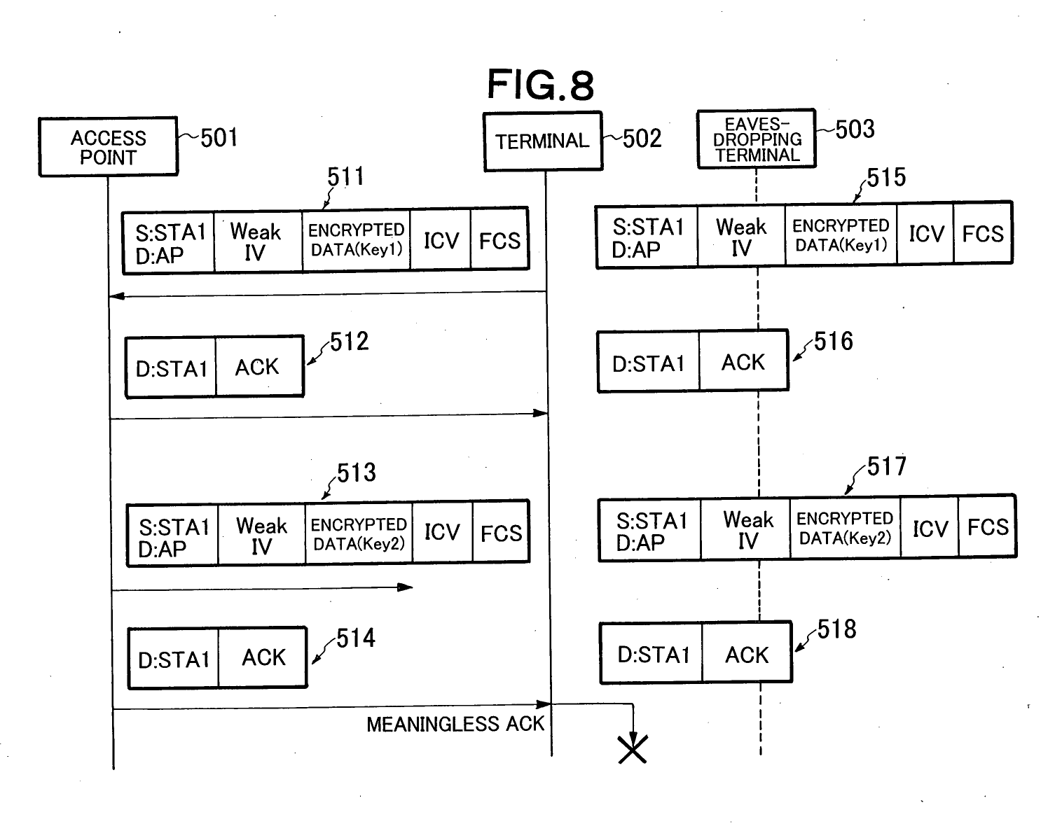

A second embodiment of the present invention will be described below with reference to FIGS. 7 and 8.

The fundamental data structure and terminal configurations of the second embodiment are the same as those of the first embodiment. Here, a modified portion of the data structure and operation will be described.

In the present embodiment, the source and destination of the packet that the access point 501 transmits are STA1 and AP, respectively. The packet that the access point transmits is a packet that the access point 501 transmits to the access point 501 itself. The existence of the above packet is unlikely under normal circumstances.

Further, also in the present embodiment, the access point 501 transmits an ACK packet after transmitting a packet to the access point 501 itself. This is a dummy packet for pretending that the packet reception has been normally completed.

FIG. 7 is a flowchart showing an example of the operation of the access point 501 of the wireless LAN system according to the present embodiment.

As shown in FIG. 7, when the access point 501 receives a packet that has been encrypted with the WEP encryption method (step S501), the access point 501 transmits an ACK packet (step S502).

The access point 501 then determines whether the IV of the received packet is Weak IV or not (Step S503). When the IV of the received packet is Weak IV (Yes in step S503), the access point 501 transmits, to the access point 501 itself, a disturbance packet that has been encrypted with Weak IV and an encryption key different from an ordinarily used one (step S504).

Next, the access point 501 transmits the dummy ACK packet again (step S505) and ends the processing flow.

The eavesdropping terminal 503 receives all the packets that the access point 501 and terminal 502 transmit.

The ACK packet is not transmitted after the transmission of the disturbance packet in the first embodiment, so that it is possible for a clever eavesdropper to determine that the disturbance packet is a packet for preventing eavesdropping from the absence of the ACK packet. In the present embodiment, on the other hand, the ACK packet is transmitted after the transmission of the disturbance packet, so that an eavesdropper is difficult to determine whether the transmitted packet is the disturbance packet or not. Therefore, the packets in the system according to the second embodiment is more unlikely to be intercepted than those in the system according to the first embodiment.

FIG. 8 is a sequence diagram showing a packet communication between terminals according to the present embodiment.

As shown in FIG. 8, the packets exchanged between the access point 501 and terminal 502 are monitored by the eavesdropping terminal 503. The packets that have been encrypted with the first encryption key and packets that have been encrypted with the second encryption key are exchanged between them.

The terminal 502 transmits WEP encrypted packet 511 to the access point 501 and the eavesdropping terminal 503 eavesdrops on WEP encrypted packet 515 from the terminal 502. The access point 501 transmits ACK packet 512 to the terminal 502 and the eavesdropping terminal 503 eavesdrops on ACK packet 516 from the access point 501. Subsequently, The access point 501 transmits WEP encrypted packet 513 to the access point 501 itself and the eavesdropping terminal 503 eavesdrops on WEP encrypted packet 517 from the access point 501. The access point 501 transmits ACK packet 514 to the terminal 502 and the eavesdropping terminal 503 eavesdrops on ACK packet 518 from the access point 501.

In the first and second embodiments, it is possible to prevent decryption based on the Weak IV collection without reconfiguration of the existing wireless LAN equipment and the terminal equipment currently used.

What is claimed is:

1. A method for preventing eavesdropping in a wireless communication system that includes an access point and a terminal exchanging, with said access point, a packet that has been encrypted with a first encryption key that has been previously set on the basis of a Wired Equivalent Privacy (WEP), said method comprising the steps of:
determining at said access point whether the packet includes a Weak Initial Vector (Weak IV) having a specified bit pattern, when said access point receives the packet, and
transmitting from said access point a disturbance packet that has been encrypted with a second encryption key different from the first encryption key, when the packet includes the Weak IV.

2. The method according to claim 1, wherein the disturbance packet is transmitted again after a predetermined time has passed after transmission of the previous disturbance packet.

3. The method according to claim 1, wherein the disturbance packet is transmitted to said access point and then an acknowledgement (ACK) packet is transmitted.

4. A wireless communication system comprising:
an access point; and
a terminal exchanging, with said access point, a packet that has been encrypted with a predetermined encryption key that has been previously set on the basis of a Wired Equivalent Privacy (WEP),
said access point comprising:
determination unit for determining whether the received packet includes a Weak Initial Vector (Weak IV) having a specified bit pattern; and
transmitter for transmitting a disturbance packet that has been encrypted with an encryption key different from the predetermined encryption key,
wherein said transmitter transmits the disturbance packet when said determination unit determines that the received packet includes the Weak IV.

5. The wireless communication system according to claim 4, wherein
said access point further comprises a timer for measuring a predetermined time, and
the disturbance packet is transmitted again after detecting that a predetermined time has passed after transmission of the previous disturbance packet by using said timer.

6. The wireless communication system according to claim 4, wherein
said transmitter further transmits an acknowledgement (ACK) packet and the ACK packet is transmitted after the disturbance packet has been transmitted to said access point itself.

7. An access point of a wireless communication system including the access point and a terminal exchanging, with said access point, a packet that has been encrypted with a predetermined encryption key that has been previously set on the basis of a Wired Equivalent Privacy (WEP), said access point comprising:
determination unit for determining whether the received packet includes a Weak Initial Vector (Weak IV) having a specified bit pattern; and
transmitter for transmitting a disturbance packet that has been encrypted with an encryption key different from the predetermined encryption key,
wherein said transmitter transmits the disturbance packet when the determination unit determines that the received packet includes the Weak IV.

8. The access point according to claim 7, further comprising a timer for measuring a predetermined time, said disturbance packet being transmitted again after detecting that a predetermined time has passed after transmission of the previous disturbance packet by using said timer.

9. The access point according to claim 7, wherein
said transmitter further transmits an acknowledgement (ACK) packet and the ACK packet is transmitted after the disturbance packet has been transmitted to said access point itself.

10. A program product embodied on a storage unit of a computer and comprising code that, when said program product is executed, cause said computer to perform a method comprising the steps of:
determining at said access point whether the packet includes a Weak Initial Vector (Weak IV) having a specified bit pattern, when said access point receives the packet, and
transmitting from said access point a disturbance packet that has been encrypted with a second encryption key different from the first encryption key, when the packet includes the Weak IV.
